(19) United States
(12) Patent Application Publication
(10) Pub. No.: US 2011/0252660 A1
(43) Pub. Date: Oct. 20, 2011

(54) Optimisation of a Drying Process in a Rotary Dryer for Mineral Materials

(75) Inventors: Erik Spangenberg Hansen, Ostbirk (DK); Bent Nielsen, Kjellerup (DK); Jesper B. Rasmussen, Brabrand (DK); Martin N?rtoft Thomsen, Kjellerup (DK)

(73) Assignee: KVM Industrimaskiner A/S, Kjellerup (DK)

(21) Appl. No.: 13/127,781

(22) PCT Filed: Nov. 4, 2009
(86) PCT No.: PCT/DK2009/050290

§ 371 Date: Jun. 28, 2011

(30) Foreign Application Priority Data
Nov. 5, 2008 (DK) PA200801523

(51) Int. Cl. F26B 21/00

(52) U.S. Cl. 34/89

(57) ABSTRACT

The system is peculiar in that there is provided a number of temperature sensors inside a rotary dryer, the sensors indicating a representative temperature of the materials dried/heated in the zone in which the sensor in question is located. By combining the measured temperatures with indications/measurements of flow, temperature and humidity of the materials to be dried, and temperature and humidity of the flue gas, a regulating unit/system with a simple mathematical model of the drying process may control the oil or gas burner optimally, such that the energy consumption for the drying process is minimised, and the waste of material occurring by too much or too little heating, typically by start and shutdown, is almost eliminated. The system may be used both by concurrent and countercurrent rotary dryers, respectively, and by single as well as double chambered rotary dryers, respectively, for drying and heating mineral materials, primarily for asphalt production.

This application claims the benefit of Danish Application No. PA 2008 01523 filed Nov. 5, 2008 and PCT/DK2009/050290 filed Nov. 4, 2009, which are hereby incorporated by reference in their entirety as if fully set forth herein.

### FIELD OF THE INVENTION

The present invention concerns a system for optimising the drying process in a rotary dryer.

### OBJECT OF THE INVENTION

It is the object of the invention to provide a system for optimising the drying process such that the energy is utilised optimally and waste of energy and materials is avoided or diminished.

### BACKGROUND OF THE INVENTION

From GB 1244569 is known a rotary dryer for drying e.g. aggregate materials. A first temperature sensor is arranged inside the dryer close to the inlet of the material and a second temperature sensor is arranged close to the outlet of the material from the dryer. By measuring the temperatures at the inlet and the outlet, respectively, the quality of the drying achieved in the material in question may be assessed. This means that if the amount or composition, including the moisture content, is changed in the material, an adjustment of the drying temperature of the dryer will only be discovered and adjusted after the material having passed the dryer. Thus there will never be optimal drying conditions for the actual amount of material and composition in the dryer. A similar arrangement is disclosed in JP4194107.

From U.S. Pat. No. 5,083,870 is known a mobile rotary dryer in which is installed a number of temperature sensors externally along the whole dryer. The drying process is controlled hereby. As the sensors are arranged far from the material, hereby enabling other factors to have influence, as well as the amount of material, the texture and the speed can change the progress of drying without the sensors detecting it in time for regulating the process, there is provided a drying process where, in order to be sure to attain the desired degree of dryness in the material, there is a risk of overdrying, i.e. either using too much time per drying process or having too high temperature or too little material in the dryer. Obviously, this entails an inferior utilisation of the resources in the dryer.

### DESCRIPTION OF THE INVENTION

The system is characterised in that a number of temperature sensors are disposed inside the dryer drum. The sensor shows a representative temperature of the material dried/heated in the zone in which the sensor concerned is disposed. By combining the measured temperatures with indications/measurements of flow, temperature and humidity of the materials to be dried, and temperature and humidity of the flue gas, a control unit/system with a simple mathematical model of the drying process may control the oil or gas burner optimally such that the energy consumption of the drying process is minimised, and the waste of material occurring by too much or too little heating, typically by start and shutdown, is almost eliminated.

The drying process for drying mineral materials, hereinafter generally termed stone materials, for asphalt production, is an energy-consuming process. Besides drying, the stone materials, the stone materials must be heated to about 200° C. in order to have a proper temperature for asphalt production. How hot the stone materials have to be depends on the asphalt to be made. However, in order to ensure that the finished asphalt has the correct temperature when leaving the mixer, the stone materials are to be heated to an excess temperature which depends on how great the heat loss is from the time when the stone materials leave the rotary dryer until they are used in the mixer, and on whether the mixed materials have the correct end temperature. On the other hand, the materials must not be overheated too much as decomposition of the binder (bitumen) will otherwise occur.

At the same time, the temperature in the finished asphalt is also to be sufficiently high so that the heat loss occurring from time the asphalt leaves the mixer, is stored in end product silos, loaded on lorries, transported to laying machines and finally laid out and compacted, is not greater than what is acceptable.

The rotary dryer may be of concurrent as well as of countercurrent type.

By means of temperature sensors disposed in the rotary dryer, the system may show how the temperature progresses throughout the rotary dryer. Optimal function of the system depends on the sensors having a short reaction time. Therefore, requirements to the incorporation of the sensors in the drum and the reaction time of the sensors are crucial for optimal effect.

The difference between the temperatures in the various zones is an indication of the evaporation and/or heating occurring in the individual zones, and thereby an indication of the energy used.

The whole process, from the mineral materials being dosed in a cold dosing until they end as finished laid asphalt, therefore require a thorough and optimal control of the temperature in order to ensure that no more energy than necessary is supplied. At the same time, control of the temperature is also to be optimal in order to minimise wasteful heating of materials and to minimise the amount of asphalt to be scrapped.

A good, and optimal temperature control/detection at the right spots contributes to that only required energy is supplied to the drying and heating process where the largest amount of energy is used. This purpose is achieved by an energy control system as indicated in claim 1.

Additional preferred embodiments are defined in the dependent claims.

Normally, this drying and heating process is effected in, a rotary dryer where it is difficult to measure the temperature during the process itself. Typically, the temperature has been measured just before the materials are transported into the rotary dryer, and then it has not been possible to detect the temperature before the dried and heated materials have left the rotary dryer. If the temperature of the materials is not high enough or too high, it is necessary to scrap the materials at first. The materials may then be run through the drum again in order to attain the right temperature with consequent unnecessary excess energy consumption.

By double-chambered dryers, the stone material is dried and heated in an inner chamber after which the materials leave the inner chamber and, are conducted to an outer chamber. Then the stone materials are frequently added a portion of recycled materials and bitumen. One of the advantages of double-chambered dryers is the possibility of reusing a larger amount of recycled materials which of course are crushed/sorted to suitable particle size fractions in beforehand. The heating and mixing process continues in the outer chamber. Here, it has only been possible to detect the temperature on the finished asphalt at the outlet of the second (outer) chamber. If the asphalt is too hot or too cold, the asphalt has to be scrapped. In these types of dryers there is typically a very great loss during initiation and termination of the production. If the asphalt has been too hot, it is to be completely scrapped (since the binder, bitumen, degenerates or cokes), and if the asphalt has not been hot enough, it can be used again but it is difficult to control a renewed run of the insufficiently hot asphalt if it is not cooled completely before going through second step again. This causes great loss of resources.

The equipment and the system according to the invention in its simplest embodiment provides the operator with a quick overview of how the temperature develops in the stone materials in the rotary dryer. The operator has the possibility of reacting, i.e. changing the process parameters by change in materials, capacity and humidity, thereby achieving possibility of getting a more uniform temperature in the finished asphalt.

In its simplest embodiment, the equipment consists of a number of rapidly reacting temperature sensors with building-in kits for mounting in the drum casing such that the actual stone material temperature is measured in the zones where the temperature sensor is located. The individual temperature sensors are mounted such that they sit in a lifter or burner lifter, cooperating with the lifter during the whole rotation such that the right temperature is achieved with the least possible wear. The sensors are mounted in selected zones in the drum such that the temperatures being most representative throughout the drum are measured.

The sensors are connected to an installation box in which a wireless transmitter and a battery are located. The battery provides supply voltage for the temperature sensors and for the transmitter which wirelessly sends the signals to a receiver which is arranged close to the rotary dryer. Here, the receiver receives the wirelessly transmitted signals. From here the signals are transmitted via cables to regulator and/or a display unit.

In the examples shown later, four quick-reacting temperature sensors are used.

In DE 100 46 289 A1, Herbert Rosenthal et al have described a method for detecting the temperature in the stone materials inside the rotary dryer itself, but they are limited to only using one temperature sensor which via a special lifter protects the sensor against wear. Furthermore the sensor is built into a complicated (and fragile) two chamber construction, where material from the rotating dryer will come into contact with the sensor, and be replaced with every rotation of the dryer, thereby creating widely changing temperature measurements varying from the gas temperature corresponding to empty chambers and material temperature when the chambers are filled with material. Furthermore the continuous replacement of the material causes wear, and thereby limits the effective service life of the arrangement. The drawback of this incorporation is that the temperature sensor is to be disposed in the zone of the rotary dryer where the materials are dry with certainty due to the special lifter mounting. At the same time, the special lifter design causes that changes in temperature are slowly detected.

That the temperature sensor is built into a zone where the materials are dry with certainty is inexpedient as there are many factors which are of significance to the progress of the drying of the stone materials. The temperature sensor thereby becomes disposed too far into the dryer in order to ensure optimal adjustment of the quantitative supply of energy. Besides, the slow reaction time, which is due to the special lifter design, is not advantageous with regard to ensuring optimal reaction/adjustment for controlling the energy supply.

DE 100 46 289 describes an example of a system with a temperature sensor for detecting the temperature inside the dryer shortly before the materials leaves the rotary dryer. It is thus only a limited additional value indicated by this measurement, only a few seconds before the materials are leaving the dryer anyway and the temperature can be measured in a normal way. At this stage in the drying process it is so late that it is difficult to change the final, temperature much particularly with regard to energy saving.

The time is too short to add more power such that the material temperature can be raised, and it is too late to reduce the power supply in order to lower the temperature. The position and inertia of the sensor cause that regulation of a rapid change of the inlet conditions cannot be reached in time. DE 100 46 289 includes furthermore a description of a detection of the flue gas temperature. The flue gas temperature reacts to a possible change of material flow, material composition and material humidity, but which of them is not possible to determine whereby the measurement can not be used for regulation with regard to the materials which are in a drying process inside the dryer. The change does not tell anything about whether it is flow, composition or humidity, respectively, that is changed, why it does not provide good information for the energy regulation without also knowing several parameters.

It is thus not sufficient only to use the flue gas temperature and knowledge of the material temperature in order to achieve optimal regulation.

In order to overcome these inexpediencies, in particular with regard to improving the reaction time, the present invention indicates use of a different type of temperature sensor and a changed building in of the temperature sensor. Moreover, this changed building in of the temperature sensor entails that the temperature sensor is not so dependent on the sensor being located in a zone where the materials are dry with certainty.

The integration, or building in, which we have developed provides that the sensor can be disposed in an arbitrary zone. The way of building in the sensor ensures that there are materials around the sensor, also when disposed in one of the last zones where the materials are heated up to their desired temperature.

The drying process itself proceeds firstly by a heating of the materials from the inlet temperature to a temperature about 100° C. At this temperature, the materials are dried by evaporating the moisture which is in the materials. When the materials are dry, heating of the materials may commence, and finally a stabilisation of the temperature in the material occurs before they leave the rotary dryer. By placing the temperature sensors in these different zones there may be achieved a more exact picture of the heating of the materials, and a response to a change in the materials on their way into the drying process of the drum may be given earlier.

The temperature signals from the rotary dryer are transmitted back to a control system taking care of the burner regulation on the basis of a weighting of the significance of individual sensors in the rotary dryer. By means of the temperature measurements and their relative weighting and measurement of the amount of minerals supplied to the drum, the control calculates the amount of energy to be fed to the rotary dryer in order to achieve the desired end temperatures of the minerals. In the calculations, allowance can be made for the outdoor temperature, residual heat and the indirect, or possibly direct, amount of moisture in the materials on their way into the rotary dryer.

By combining these temperature measurements with a simple mathematical model of the drying process, the energy supply itself can be controlled more accurately. If the temperature measurements in the rotary dryer is further combined with flow, temperature and humidity measurements of the materials added to the rotary dryer, and temperature and humidity measurement of the flue gas leaving the rotary dryer, there is achieved an even more exact temperature control of the stone materials and thereby a more optimised energy consumption.

By these measures the temperature measurement at the outlet of the rotary dryer only serves as a check on whether the drying process has proceeded as planned.

Previously, it was this temperature measurement of the materials after the rotary dryer together with the flue gas temperature that were used for regulating the energy supply.

For further optimising control of the energy supply, the air temperature and the air humidity of the suction air are measured and used for regulation of the burner.

A further optimisation and reduction of the energy consumption may be achieved by conducting the cleaned flue gas through a heat exchanger which then heats the suction air to the rotary dryer.

If account is taken of the mass flow of the mineral materials, the control system maybe further improved both with regard to adjustment of the heat supply and the drying process. Experience shows that about 8% of the mass flow of mineral materials into the drying process leaves the drying process together with the flue gas, and similarly the evaporated water is transported with the flue gas out of the drying process. The part of the mass flow of the mineral materials leaving the drying process together with the flue gas is separated off in the flue gas filter, partly as coarse filler and partly as fine filler. Filler leaving the drying process with the flue gas is only heated to the flue gas temperature and therefore does not receive as much energy for heating as the remaining mineral material.

The regulating algorithm may be further refined in that the mathematical model is extended such that the particle size of the mineral materials and their heat transmission properties are included. The energy consumption and the drying process may hereby be further improved.

By an optimal control of the energy supply is achieved both a reduction of the energy consumption and not the least a reduction of the waste during initiation and termination of the drying process. This reduction of waste and thereby energy is even more distinct by double-chambered dryers, where it is frequently necessary to scrap an appreciable number of tons of asphalt before the process is running at a stable temperature, and again when the drying process is terminated.

The model may also ensure that the initiation stage is run with a slight excess temperature in order to heat the entire batch of material and the storage of the materials, right from the materials are leaving the rotary dryer until the materials lie in the stone silos in the mixer tower, ready for use for making the asphalt.

The drying of mineral materials for asphalt production is an energy consuming process. The energy source is typically an oil or gas burner with a power of up to 25 MW so that even a small reduction of a few percent will be very attractive in order to reduce the cost of asphalt production.

The burner process may furthermore be optimised by measuring the oxygen percentage (O₂) and the carbon dioxide percentage (CO₂). The burner may hereby be regulated optimally.

### DESCRIPTION OF THE DRAWING

FIG. 1 shows the progress of temperature in a rotary dryer;

FIG. 2 shows integration of a temperature sensor;

FIG. 3 shows a typical disposition of four temperature sensors in a single chamber rotary dryer;

FIG. 4 shows a schematic design of the control system;

FIG. 5 shows a simplified mathematical model of the drying process.

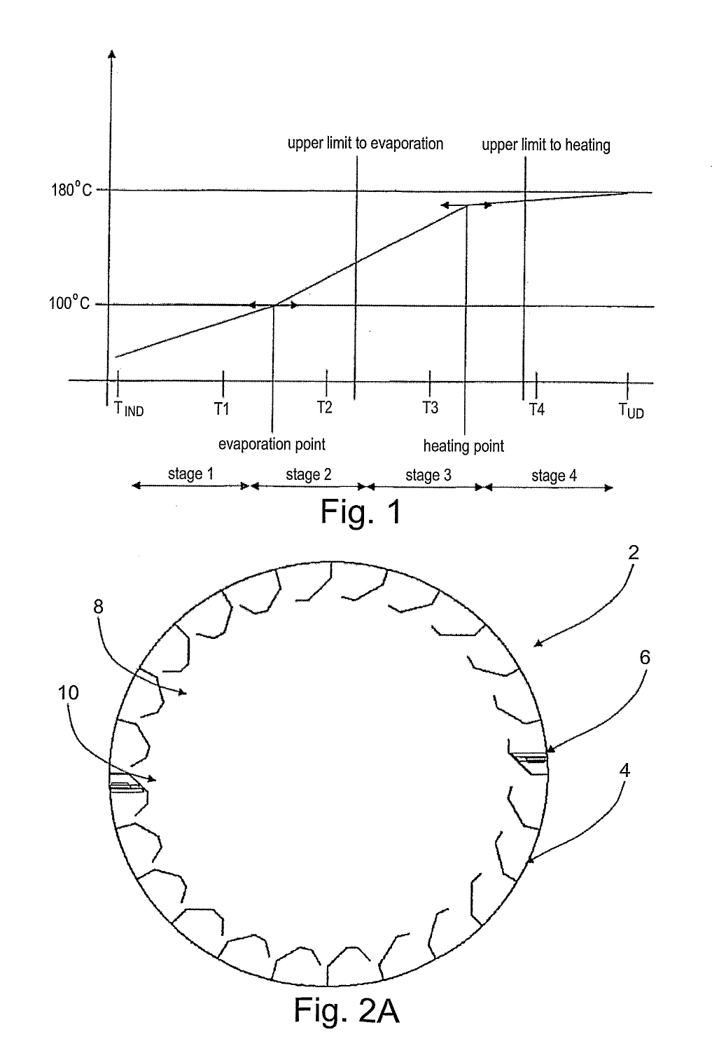

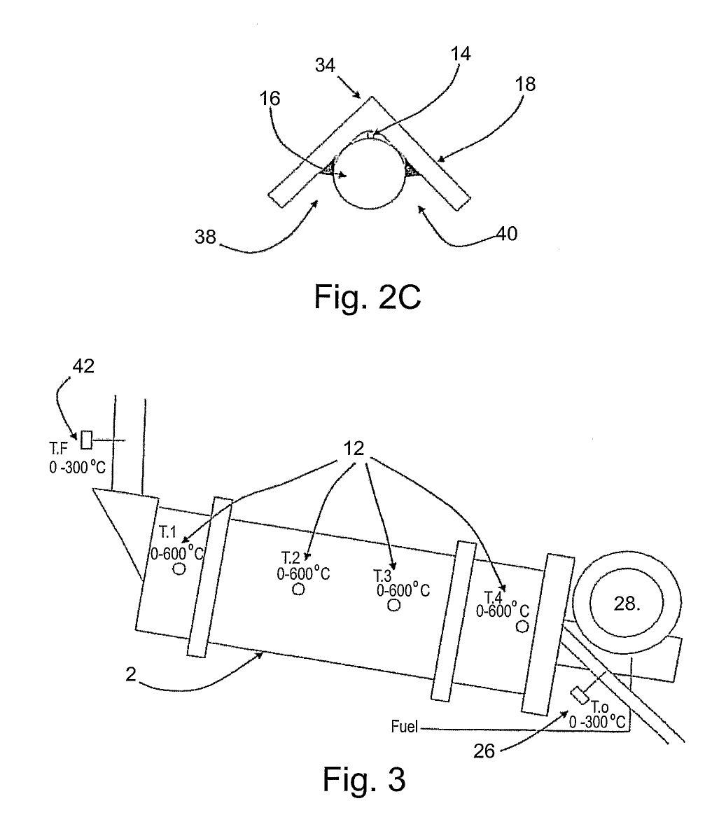

FIG. 1 shows a schematic representation of the temperature progress in a rotary dryer which is schematically illustrated in FIG. 3. The temperature progress in a rotary dryer may be divided into different stages, where stage 1 is a heating stage, where the materials are heated from the inlet temperature up to almost 100° C. Stage 2 is an evaporation stage wherein the materials are dried and the water evaporates. In this stage, the materials keep the temperature at about 100° C. Stage 3 is the next heating stage where the materials are heated from about 100° C. to about 170° C. 4. Stage 4 is a stabilisation stage wherein the temperature of the materials is stabilised at about 180° C.

On the basis of knowledge of the inlet temperature, the temperature in the first zone, the design of the rotary dryer and the conveying speed in the dryer, the point at which the temperature reaches about 100° C. may be calculated. The position of this point may wander back and forth in the rotary dryer, depending on material flow, temperature, humidity and the supplied energy. Also, the position of where in the drum the materials reach the desired temperature may determined, after which the temperature of the materials is to be stabilised (the heat is to penetrate into the larger materials). Similarly, the position of this point may wander back and forth in the rotary dryer, depending on material flow, temperature, humidity and the supplied energy. By determining upper limits to how far into the dryer these conditions, the evaporation point and the temperature stabilisation point, respectively, may be reached at the latest, the energy supply may be determined when material flow and some of the other parameters are known. In the example shown here, four temperature sensors are provided in the rotary dryer, marked by T1, T2, T3 and T4, and in addition, the inlet temperature of the materials is indicated by T_{IND} and the outlet temperature of the materials by T_{UD}.

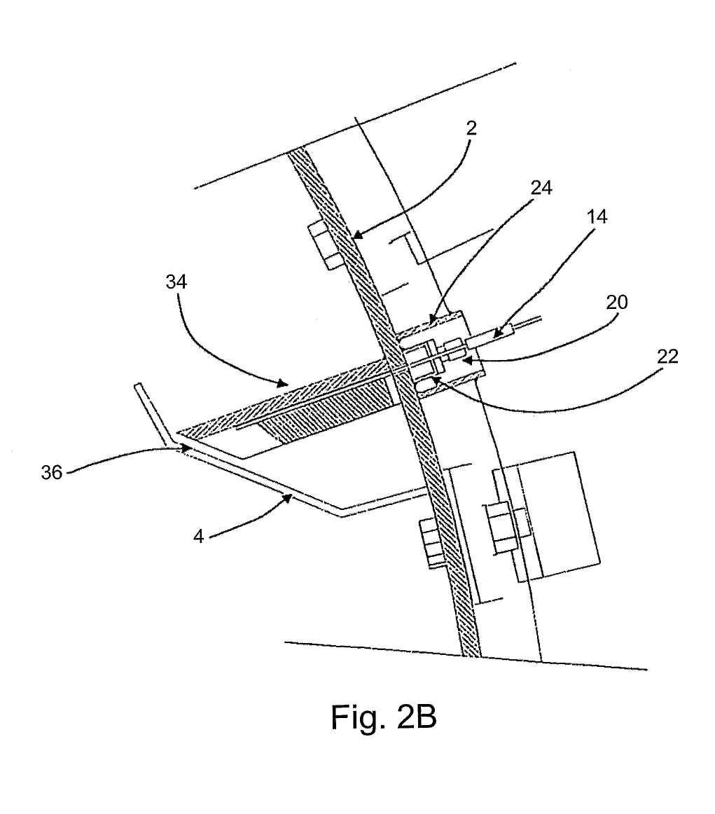

FIG. 2A shows schematically a cross-section of a rotary dryer 2. The dryer is shown by two sections, the right side with lifters 4, the left side with burner lifters 8. The lifters are designed according to the same principle, but where the lifters are designed such that the materials gradually fall off during rotation of the dryer, whereby the materials fall, down through the hot airstream through the dryer, the burner lifters are designed such that the materials are kept inside the burner lifters, whereby the materials do not fall down in the fire zone (or heating zone) of the burner. The Figure also shows how the temperature sensors are incorporated in a lifter 6 and a burner lifter 10, respectively. It is thus not all lifters/burner lifters that have built-in temperatures sensors, but only a number corresponding to what is required for following the progress of temperature inside the rotary dryer 2. The incorporation of the temperature sensor is shown in details in FIG. 2B, see the description below.

FIG. 2B shows the building in of a temperature sensor in a lifter 6 in a rotary dryer 2. The lifter 6 consists of a bent section 30 typically made of steel which in the cavity 32 formed by the section between section 30 and the inner side of the dryer 2 during its rotation collects a portion of material in proportion to the amount of material located in the dryer. The principle is that during the motion of the lifter 4, 6 around with the dryer, the lifter moves from a lower position through the materials, lifting a portion of material up and out of the mass of material. When moving up during rotation from 0 to 90° (V being the lowest point), the lifter 4,6 collects materials. During the rotation from 90 to 180′, the materials begin gradually to fall/sprinkle out from the lifter. This falling out continues during the rotation from 180 to 270′.

In some of the lifters, a temperature sensor is arranged. In order to protect the sensor, this is arranged in a guard 34. The guard is made up of an upper protection 18 and a lower protection 16 such that the temperature sensor 14 is protected. This will now be described in more detail with reference to FIG. 2C.

Some of the materials are caught by the sensor guard and lie behind the guard, such that there are materials all the time which are in contact with the guard and thereby may transmit the temperature of the materials to the sensor. During the rotation from 270 to 360′, the collected materials slip/fall down from the guard simultaneously with materials again being present in front of the guard. In order to ensure that the guard is largely emptied from materials at each down run, a free space 36 is made between sensor guard 34 and the bottom of the lifter 6. The design and position of the guard 34 relative to the lifter 6 ensures that there are, always materials in contact with the sensor such that the temperature in the materials can be transmitted to the guard in the best possible way and be detected by the quick-reacting temperature sensor.

FIG. 2C shows a section of the guard 34 where it is shown that the temperature sensor 14 lies protected between the upper protection 18, which in this case is the back side of an angle iron, and the lower protection 16, which in this case is a welded round iron. By the right ratio between the size of the angle iron and the diameter of the round iron is achieved that the temperature sensor may just fit between angle iron and round iron, thereby protecting the temperature sensor but still allowing, rapid and good transmission of the heat from the materials to the temperature sensor 14. The ratio between angle iron and round iron also provides for two indentations 38, 40 that grip/collect materials during the downwards movement of the guard 34 in the dryer.

FIG. 3 shows a typical disposition of four temperature sensors 12 in the rotary dryer 2. The drawing also shows the temperature sensor 42 measuring the temperature of the flue gas leaving the drying process and the infrared temperature sensor 26 measuring the stone temperature of the materials leaving the rotary dryer. For principle's sake, the position of the burner 28 in a countercurrent rotary dryer is also shown.

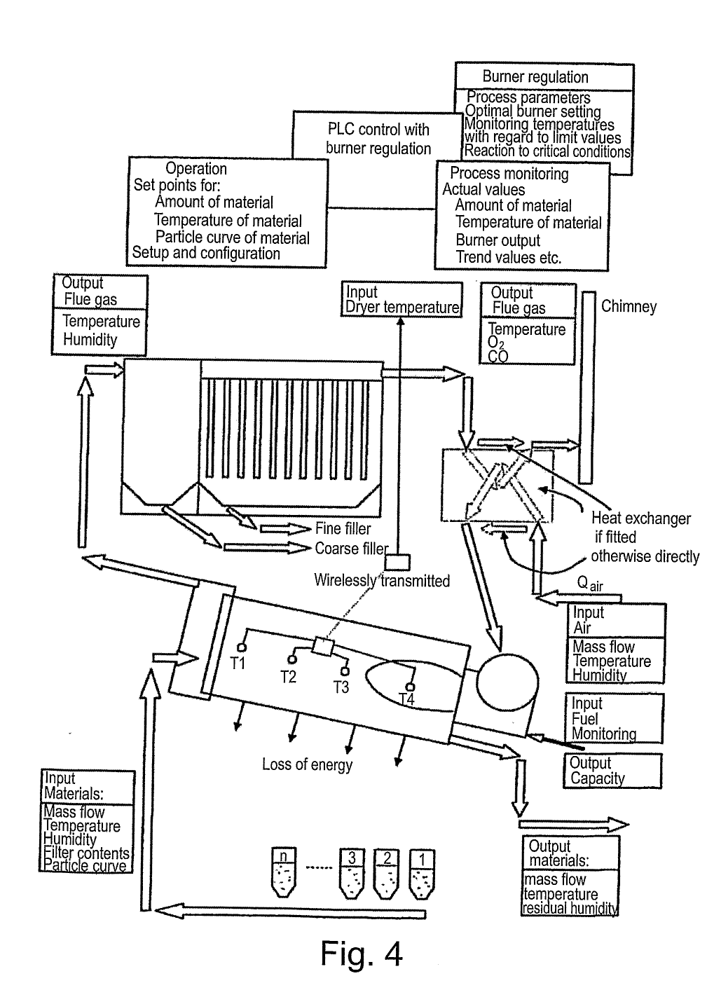

FIG. 4 shows a flow diagram of the entire drying process with the parameters forming part thereof. It is indicated which parameters are measured and sent to the control system, indicated as Input and Output, respectively, where the individual parameters form part of the process control itself. The parameter is weighted by the significance of the parameter for the process. On the basis of a wanted mass flow of dried materials at a desired temperature, the control system calculates the required energy supply. On the basis of detected parameters, the control may then regulate the supplied amount of energy and thereby the required burner output. t The control system is capable by itself of, moderating the supplied amount of energy, both during initiation and termination of the drying process such that the desired material temperature is reached without unnecessary waste.

The temperatures detected in the rotary dryer are used for calculating the position of the materials when they are in the evaporation zone, and the position of the materials when they are in the stabilisation zone. The burner control also supervises all process parameters sent to the control so that they lie within determined limit values in order to ensure that the control of the burner does not come into critical situations. The flow lines of the control signals to and from the control are not shown for reasons of clarity.

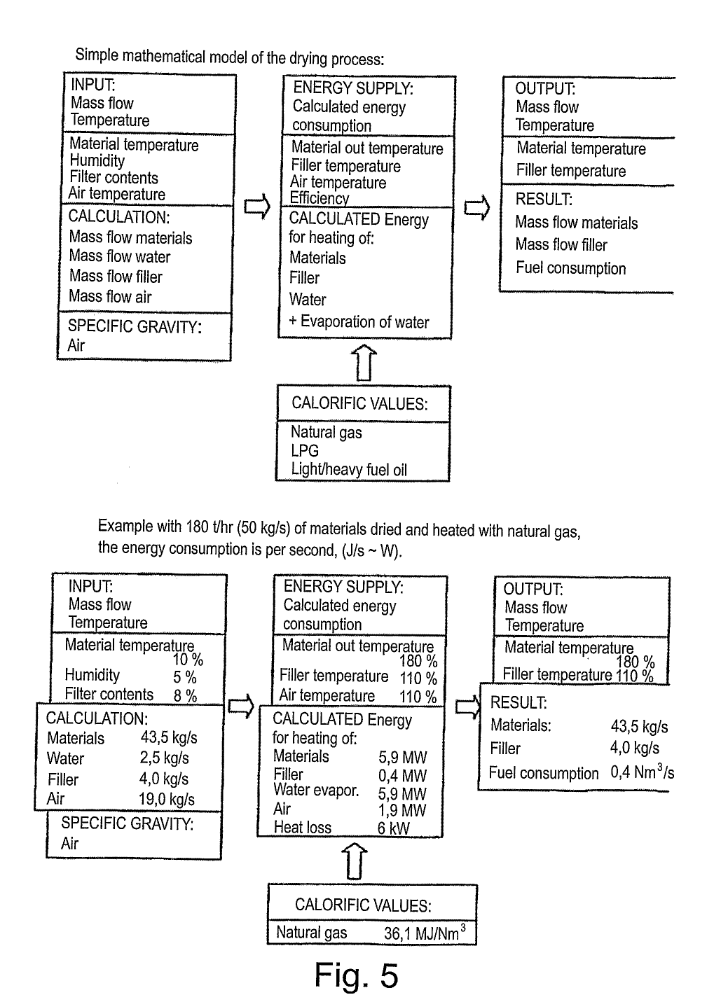

FIG. 5 shows the simple mathematical model where the parameters forming part thereof are indicated. The mathematical formulas themselves are not indicated, but the parameters and values calculated are shown.

In the example, some typical values for the measuring parameters to be used by the calculations are indicated. The parameters can be measured, calculated or estimated, depending on the degree of development of the system.

The example is the energy consumption calculated by a capacity of 180 t/hr corresponding to 50 kg/s. From the calculation example appears that about 41% is used for heating the stone materials, about 41% for heating and evaporating the water, about 3% for heating the filler, about 13% for heating the air and about 0.1% disappears as heat radiation from the rotary dryer by an insulation thickness of 50 mm rockwool. 1-2% of the supplied amount of energy disappears otherwise, here indicated as degree of efficiency.

The model provides a simple energy model of the system. The model is extended by estimations of where in the rotary dryer the evaporation point is located, and where the heating point is situated, whereby the amount of energy at varying loads, i.e. amount of material, flow etc., are better optimised such that the energy supply is not changed before the process so requires. Hereby is ensured the most uniform temperature of the heated stone materials.

### LIST OF REFERENCE NUMBERS

2 rotary dryer
4 lifters
6 lifter with temperature sensor
8 burner lifters
10 burner lifter with temperature sensor
12 temperature sensor with protective armour
14 temperature sensor
16 lower protective armour for temperature sensor
18 upper protective armour for temperature sensor with, material pocket
20 split bushing for fastening sensor with adjusting ability
22 sleeve for fastening of pos. 20
24 pipe protection by insulation
26 temperature sensor at outlet of rotary dryer, infrared
28 burner, gas or fuel oil, with blower
30 bent section
32 cavity in lifter
24 temperature sensor guard
36 free space
38,40 indentations in guard
42 flue gas temperature sensor, flue gas exiting rotary dryer

1. An energy control system for regulating energy supply to a drying process in a rotary dryer, in particular for drying mineral materials, primarily for asphalt production, wherein the rotary dryer includes means for adding air, means for discharging flue gas, and means for heating, wherein two or more temperature measurements of the mineral materials from various zones in the rotary dryer are provided, as well as measurements of/indications of material flow, material temperature and material humidity of the mineral materials before these are introduced in the rotary dryer, where a regulating algorithm, on the basis of a simple mathematical model of the drying process in the rotary dryer, by using two or more of the temperature measurements from the rotary dryer, measurement of the flue gas temperature and measurements of/indication of the material flow, material temperature and material humidity ensure an optimal control of the energy supply to the drying process in the rotary dryer such that the stone materials always have the desired temperature when they leave the rotary dryer, wherein the temperature measurements are provided by means of a number of temperature sensors, the temperature sensors being incorporated in one or more lifters and/or burner lifters inside the rotary dryer, such that the temperature sensor is protected behind a bend from the fastening of the lifters, either where it is fastened to the dryer wall or to a lifter rotation shaft arranged inside the rotary dryer.

2. Energy control system according to claim 1, wherein the temperature sensors in a rotary dryer of the type having a single chamber are at least four in number, where the rotary dryer is divided into four zones; a first heating zone, an evaporating zone, a second heating zone and a temperature stabilising zone, such that there is at least one temperature sensor in each zone.

3. Energy control system according to claim 1, wherein the temperature sensors in a rotary dryer of the type having double chambers are at least six in number, where the rotary dryer is divided into four zones; a first heating zone, an evaporating zone, a second heating zone and a temperature stabilising zone, and that at least one temperature sensor is provided at the entrance to the second chamber and one temperature sensor about the centre of the second chamber.

4. Energy control system according to claim 1, wherein the humidity in the flue gas from the rotary dryer and/or the temperature of the intake air for the drying process and/or the air humidity of the intake air for the drying process are measured and used in the control system.

5. Energy control system according to claim 1, wherein the mass flow from the drying process is detected by weighing and registering the mineral materials out of the rotary dryer and the amount of filler collected in a flue gas filter.

6. Energy control system according to claim 1, wherein the intake air for the drying process is preheated by the cleaned flue gas, i.e. the flue gas from the drying process that has passed a flue gas filter.

7. Energy control system according to claim 1, wherein the mathematical model includes particles sizes of the mineral materials and heat transmission properties in the transmission of heat from the air flow to the individual particles and the heat radiation from the means for heating the individual particles, for further optimisation of the control algorithm.

8. A rotary dryer for drying preferably mineral materials, wherein the rotary dryer includes a rotary cylindric drum which in use is arranged with the rotary axis at an angle deviating from horizontal, where on the inner wall of the cylindric drum a number of lifters are arranged, where inside a number of the lifters a temperature sensor is arranged, the temperature sensors capable of transmitting temperature measurements from the sensor to a central collecting storage.

9. Rotary dryer according to claim 8, wherein each temperature sensor is mounted in a guard, the guard protecting the sensor, where the guard may have an upper and a lower protection profile made of a heat-conducting material which, together at least partially surrounds the temperature sensor, and that the guard may optionally be designed such that it temporarily retains some of the mineral material.
